(19) United States
(12) Patent Application Publication
(10) Pub. No.: US 2018/0029161 A1
(43) Pub. Date: Feb. 1, 2018

(54) METHOD FOR THE VACUUM LASER WELDING OF AN AT LEAST TWO-PART WORKPIECE

(71) Applicant: Felsomat GmbH & Co. KG, Konigsbach-Stein (DE)

(72) Inventors: Fabian Witte, Tiefenbronn (DE); Jürgen Peschina, Knittlingen (DE)

(21) Appl. No.: 15/727,584

(22) Filed: Oct. 7, 2017

Related U.S. Application Data
(63) Continuation of application No. PCT/EP2016/055903, filed on Mar. 18, 2016.

(30) Foreign Application Priority Data
Apr. 8, 2015 (DE) 10 2015 206 237.6

(51) Int. Cl. B23K 26/08; B23K 26/12

(52) U.S. Cl. CPC B23K 26/0823; B23K 26/1224

(57) ABSTRACT

A method for the vacuum laser welding of an at least two-part workpiece includes a workpiece or a workpiece carrier, on which the workpiece is arranged, and a welding mask which are moved relatively toward one another and pressed against one another so that a welding chamber is enclosed and sealed in a gas-tight manner. The welding mask is rotatably mounted. The welding chamber is evacuated and an annular connecting region between at least two workpiece parts of the workpiece that is exposed to the vacuum in the welding chamber is welded by a laser beam. The workpiece or the workpiece carrier together with the workpiece and the welding mask are turned in relation to the welding mask holder. Air is admitted to the welding chamber and the workpiece or the workpiece carrier on which the workpiece is arranged and the welding mask are moved relatively away from one another.

### CROSS-REFERENCE TO RELATED APPLICATIONS

This continuation application claims priority to PCT/EP2016/055903 filed on Mar. 18, 2016 which has published as WO 2016/162182 A1 and also the German application number 10 2015 206 237.6 filed on Apr. 8, 2015, the entire contents of which are fully incorporated herein with these references.

### DESCRIPTION

### Field of the Invention

The invention relates to a method for the laser welding of an at least two-part workpiece. The invention also relates to a system for the laser welding of an at least two-part workpiece.

### Background of the Invention

A system for the laser welding of a two-part workpiece is disclosed for example by DE 20 2011 051 331 U1.

In the production of metal structures, in particular workpieces, there is often the need to weld a number of metal parts to one another. Weldings provide connections that are very robust and resistant.

Weld seams can be created manually by a worker, who heats the surface areas to be welded with a hand welding unit, for instance with a gas flame, and presses together the parts to be connected. In manual welding, however, the surface area that is heated with the hand welding unit is usually relatively large and difficult to keep under control.

In order to be able to create weldings in a more precise and controlled manner, welding by means of an electron beam has become known. The electron beam propagates from an electron gun through a vacuum to the workpiece to be welded. The electron beam can heat a workpiece in a very small surface area.

For electron-beam welding, the workpiece is usually fed into a vacuum chamber through a door; however, it takes a long time to evacuate the comparatively large volume of the vacuum chamber after a change of workpiece.

It is known from the company publication from pro-beam AG & Co. KGaA, Planegg, DE, with the title “Elektronenstrahlschweiβen Grundlagen einer faszinierenden Technik” [Electron-beam welding, principles of a fascinating technique], section 6.2.2 Taktmaschine [Indexing machine] to set up two workpiece carriers, for a loading position and a working position, on a turntable. In the working position, one workpiece carrier with a workpiece loaded on it can be brought up to the downwardly open housing of a vacuum chamber, so that the housing is sealed and can be evacuated. Then, the electron-beam welding can take place. With this construction, the vacuum chamber can be made relatively small.

However, electron guns for electron-beam welding are expensive and can easily be damaged by infiltrations of air.

The welding of workpieces can also be performed by means of a laser beam. By means of the laser beam, weldings that are likewise very precise and can be controlled well can be created. Lasers are also comparatively robust and inexpensive.

DE 20 2011 051 331 U1 discloses a rotary table machine tool with a laser welding station in which a cup-shaped workpiece pallet with a two-part workpiece is raised by a handling device out of a rotary table and brought up to a receiving opening in a housing from below. A laser is arranged in the housing, and the housing together with the introduced workpiece pallet seals a laser processing space in a light-tight manner for the light of the laser. The workpiece is processed with the laser. Arranged in the housing is a welding mask, which is integrated in a welding mask holder and covers the workpiece in order to protect it from being contaminated during the laser processing. For sweeping the workpiece with the laser beam, the workpiece pallet can be turned by means of the handling device.

### SUMMARY OF THE INVENTION

### Object of the Invention

The invention is based on the object of presenting a method for the laser processing of at least two-part workpieces, with which high-quality laser processing can be performed with short downtimes.

### BRIEF DESCRIPTION OF THE INVENTION

This object is achieved by a method for the vacuum laser welding of an at least two-part workpiece, with the following steps:

a) the workpiece or a workpiece carrier, on which the workpiece is arranged, and a welding mask are moved relatively toward one another and pressed against one another, so that a welding chamber is enclosed and sealed in a gas-tight manner by the workpiece and/or the workpiece carrier, the welding mask and a welding mask holder, in which the welding mask is rotatably mounted;
b) the welding chamber is evacuated;
c) an annular connecting region between at least two workpiece parts of the workpiece that is exposed to the vacuum in the welding chamber is welded by a laser beam, wherein the laser beam propagates through the welding chamber, and wherein the workpiece or the workpiece carrier together with the workpiece and the welding mask are turned in relation to the welding mask holder;
d) air is admitted to the welding chamber;
e) the workpiece or the workpiece carrier on which the workpiece is arranged and the welding mask are moved relatively away from one another.

With the method according to the invention, it is possible to set up a vacuum in an easy and quick way in the vicinity of an annular connecting region of two parts of a workpiece that is to be welded. For this purpose, a welding chamber is set up by the workpiece and/or the workpiece carrier, as well as by the welding mask and a welding mask holder. The welding chamber is sealed by moving the workpiece or the workpiece carrier to the welding mask. With this geometry, the welding chamber only requires a very small space, which can be evacuated quickly.

In the vacuum (preferably at a maximum of 100 mbar, usually in the low-pressure range around 10 mbar), the laser welding can be performed with high quality. On the one hand, only few welding beads and metal spatter are generated during the vacuum welding; there is scarcely any soot. On the other hand, oxidation processes at the weld seam can be avoided, or at least limited.

According to the invention, the welding mask is mounted rotatably in a welding mask holder. As a result, the welding mask can rotate together with the applied workpiece or the applied workpiece carrier. This facilitates considerably the sealing between the welding mask on the one hand and the applied workpiece or applied workpiece carrier on the other hand, since during the rotational movement there is no relative movement of these components. Furthermore, the sealing of the welding mask in the welding mask holder during the rotating movement can likewise be set up relatively easily, since the welding mask can be kept the whole time in the welding mask holder.

The welding mask protects the workpiece and/or the interior of the welding chamber and/or the surroundings from being contaminated by the laser welding. The welding mask holder is usually of a stationary form (therefore does not move or turn for processing the workpiece). The workpiece consists at least partially, preferably completely, of metal, in particular steel. Typical workpieces that are welded in the course of the method are toothed workpieces such as gearwheels and gear mechanisms.

Preferred Variants of the Invention

In the case of an advantageous variant of the method according to the invention, on the welding mask holder there is formed an incoupling window, through which the laser beam is introduced into the welding chamber in step c). The laser beam can then be generated away from the welding mask holder, and the welding chamber can be made particularly compact.

Preferred is a variant in which the welding mask holder is fixed in place during the entire method, and in step a) the workpiece or the workpiece carrier is moved to the welding mask, and in step e) the workpiece or the workpiece carrier is moved away from the welding mask. This makes it easier for the welding chamber to be accessed by way of the welding mask holder, in particular with respect to the introduction of a laser beam and the evacuation of the welding chamber. Moreover, the mobility of the workpiece or workpiece carrier can also be used for changing the workpiece.

An advantageous further development of this variant provides that before step a) the workpiece or the workpiece carrier is moved by means of a mobile table, in particular a rotary table, under the welding mask holder, and during step a) the workpiece or the workpiece carrier is lifted out of the mobile table, and that during step e) the workpiece or the workpiece carrier is placed on the mobile table, and after step e) the workpiece or the workpiece carrier is moved by means of the mobile table away from the welding mask holder. The mobile table, in particular rotary table, allows a quick exchange of the workpiece to be welded. The lifting out can be performed by a dedicated handling device (independent of the mobile table), which reduces the structural complexity. Moreover, the lifting out can compensate for a positioning inaccuracy of the mobile table.

Also advantageous is a variant in which during step c) suction is constantly applied to the welding chamber, in particular with a constant pumping power, and gas is constantly admitted to the welding chamber, in particular with a constant gas stream. This procedure allows a defined gas pressure that is particularly suitable for the desired laser processing to be set. By means of a (gentle) gas stream in the welding chamber, contaminants can be transported away from the welding site (from the point of laser impingement) and deposits in the welding chamber can be reduced. The gas may be for example nitrogen or a noble gas; in the case of some applications, atmospheric air also comes into consideration as the gas. Preferably, a constant pressure, usually around 5-20 mbar, is maintained in the welding chamber during step c). If necessary, for this the gas pressure in the welding chamber may be continually measured and the admitted gas flow controlled; usually, however, a permanently set admitted gas flow is sufficient.

In the case of an advantageous further development of this variant, it is provided that in the welding mask holder there is formed a substantially straight laser channel, in which the laser beam propagates in step c) and which narrows toward a point of impingement of the laser beam at the connecting region, wherein in step c) the gas is admitted in a portion of the laser channel that is away from the connecting region,

and that in the welding mask holder there is formed a substantially straight suction channel, which is at least approximately aligned with the point of impingement of the laser beam, in particular wherein the suction channel widens away from the point of impingement, and wherein in step c) pumping out takes place at an end of the suction channel that is remote from the connecting region. As a result, a gentle, uniform (laminar) gas stream can be set up over the point of impingement of the laser beam, whereby the quality of the processing of the workpiece is improved. The narrowing laser channel, and possibly also the widening suction channel, thereby produce a nozzle effect, by which the gas atoms or gas molecules flow particularly quickly in the region of the point of impingement of the laser. The laser channel narrowed near the point of impingement of the laser also minimizes contamination of the laser channel, and in particular of an incoupling window at the end of the laser channel.

System According to the Invention for Laser Welding

The scope of the present invention also covers a system for the laser welding of an at least two-part workpiece, comprising:

the workpiece or a workpiece carrier for the workpiece,

a welding mask holder, and

a welding mask with an abutment for the workpiece and/or the workpiece carrier, which is characterized

in that the welding mask is mounted on the welding mask holder rotatably about an axis of rotation DA,

in that a first, peripheral seal is arranged on the welding mask or welding mask holder,

and a second, peripheral seal is arranged on the welding mask or on the workpiece carrier,

so that when there is a workpiece and/or a workpiece carrier lying against the abutment of the welding mask, there is formed a gas-tight welding chamber, which is bounded by the welding mask, the welding mask holder and the workpiece and/or the workpiece carrier,

wherein the first seal seals the welding mask holder with respect to the welding mask, and the second seal seals the welding mask with respect to the workpiece and/or the workpiece carrier,

and in that in the welding mask holder there is formed a suction channel, by way of which the welding chamber can be evacuated. With this system, a welding chamber that is compact, and consequently can be evacuated quickly, can be set up in an easy way. The rotatability of the welding mask in the welding mask holder allows the abutting workpiece or the abutting workpiece carrier to be turned together with the welding mask with respect to the welding mask holder for the sweeping of a weld seam on the workpiece, which facilitates the sealing of the welding chamber by the first and second seals. Under a vacuum, weld seams of a particularly high quality can be produced. The system according to the invention is set up in particular for carrying out the method according to the invention that is described above or one of its variants.

In the case of an advantageous embodiment of the system according to the invention, there is also a vacuum pump, which is connected to the suction channel. After placing the workpiece and/or the workpiece carrier against the abutment, the welding chamber can be evacuated by the vacuum pump, and if desired pumping can also be continued during the laser processing on the workpiece, in particular in order to set up a (gentle) gas stream over a point of laser impingement on the workpiece.

In the case of one embodiment there is advantageously a venting valve, with which air can be admitted to the welding chamber, in particular wherein the venting valve is arranged at a connecting line to a vacuum pump that is connected to the suction channel. With the venting valve, the ambient pressure (usually about 1 bar) can be established in the welding chamber easily and quickly after the laser processing, in order to allow the workpiece or workpiece carrier to be withdrawn from the abutment.

In the case of an advantageous embodiment, it is provided that on the welding mask holder there is formed a slide which can move along the axis of rotation DA and which is pretensioned by a spring force into a position moved away from the rest of the welding mask holder, that arranged on the slide is an abutting element for abutting the workpiece, wherein the abutting element is mounted on the slide rotatably about the axis of rotation DA, and that arranged on the abutting element is a third, peripheral seal, with which a bore in the workpiece can be sealed when the workpiece is lying against the abutting element. This makes it possible to set up a particularly compact welding chamber also in the case of a workpiece with a bore. The sealing of the bore takes place by way of the slide at an end of the bore that is facing the welding mask holder, so that there is no need for the entire workpiece to be received in the welding chamber. The slide and the abutting element, which can be regarded as part of the welding mask holder, are movable in the welding chamber, or play a part in bounding it.

Also advantageous is a further embodiment, in which an incoupling window for a laser beam is formed on the welding mask holder, in particular at an outer end of an incoupling window holder that protrudes from the rest of the welding mask holder. Typically arranged in front of the incoupling window is the front end of an optical fiber, which radiates the laser beam of a laser connected to the rear end of the optical fiber into the incoupling window by way of a welding optical system. The laser is preferably a solid-state laser (diode laser).

In the case of a preferred embodiment, it is provided that a substantially straight laser channel for the propagation of a laser beam is formed in the welding mask holder, wherein the laser channel narrows toward the workpiece to be welded, that an inlet for a gas is set up at a portion of the laser channel that is remote from the workpiece to be welded, that the suction channel is at least approximately aligned with a point of impingement of the laser beam on the workpiece to be welded, and furthermore the laser channel is aligned with the point of impingement of the laser beam on the workpiece to be welded, and that the suction channel is formed as substantially straight, in particular wherein the suction channel widens away from the workpiece to be welded. As a result, a gentle, uniform (laminar) gas stream can be set up over the point of impingement of the laser beam, whereby the quality of the processing of the workpiece is improved. The narrowing laser channel, and possibly also the widening suction channel, thereby produce a nozzle effect, by which the gas atoms or gas molecules flow particularly quickly in the region of the point of impingement of the laser. The laser channel narrowed near the point of impingement of the laser also minimizes contamination of the laser channel, and in particular of an incoupling window at the end of the laser channel.

Advantageous is a further development of this embodiment in which the suction channel and the laser channel open out with their ends that are facing the point of impingement of the laser beam into a main space of the welding chamber, wherein the ends have a center-to-center distance less than or equal to ⅔ of the inside diameter, preferably less than or equal to ½ of the inside diameter, of the main space. The fact that the ends of the laser channel and the suction channel are relatively closely adjacent means that the gas stream is confined to a narrow space, whereby the flow velocity of the gas atoms or gas molecules is kept high, and particularly good transporting away of contaminants from the weld seam can take place.

Particularly preferred is an embodiment in which the volume of the welding chamber is 5 liters or less, preferably 3 litres or less, and in particular between 0.2 l and 2.5 l. A welding chamber with such a volume can be evacuated or pumped to the pressure desired for the laser processing particularly quickly after a change of workpiece.

Also advantageous is an embodiment in which the welding mask is formed with an annular wall, wherein a first end-face opening is covered by the welding mask holder, and a second end-face opening, which is bounded by the abutment, can be covered by the workpiece and/or by the workpiece carrier. This geometry is particularly well-suited for the rotatable mounting of the welding mask in the welding mask holder and for the forming of a gas-tight or vacuum-tight welding chamber. The workpiece can protrude well into the region at the height of the annular wall.

The scope of the present invention also includes the use of a system according to the invention, described above, in a method according to the invention, described above.

Further advantages of the invention emerge from the description and the drawing. Similarly, the features mentioned above and the features still to be set out can each be used on their own or together in any desired combinations according to the invention. The embodiments shown and described should not be understood as an exhaustive list, but rather as being of an exemplary character for the description of the invention.

### BRIEF DESCRIPTION OF THE DRAWINGS

The invention is explained in more detail on the basis of exemplary embodiments and is represented in the drawing, in which:

FIG. 1a shows a schematic representation of a first embodiment of a system according to the invention for laser welding, wherein a workpiece is welded axially and the workpiece plays a part in sealing the welding chamber, in cross section;

FIG. 1b shows the system from FIG. 1a in a schematic sectional perspective view;

FIG. 1c shows the system from FIG. 1a in a schematic cross section, with the workpiece withdrawn;

FIG. 2a shows a schematic representation of a second embodiment of a system according to the invention for laser welding, wherein a workpiece is welded axially and a workpiece carrier plays a part in sealing the welding chamber;

FIG. 2b shows the system from FIG. 2a in a schematic sectional perspective view;

FIG. 2c shows the system from FIG. 2a in a schematic cross section, with the workpiece carrier withdrawn;

FIG. 3a shows a schematic representation of a third embodiment of a system according to the invention for laser welding, wherein a workpiece is welded radially and a workpiece carrier plays a part in sealing the welding chamber;

FIG. 3b shows the system from FIG. 3a in a schematic sectional perspective view;

FIG. 3c shows the system from FIG. 3a in a schematic cross section, with the workpiece carrier withdrawn; and

FIGS. 4a-4f show a schematic representation of the sequence of a variant given by way of example of the method for the vacuum laser welding of a workpiece according to the invention.

### DETAILED DESCRIPTION OF THE PREFERRED EMBODIMENTS

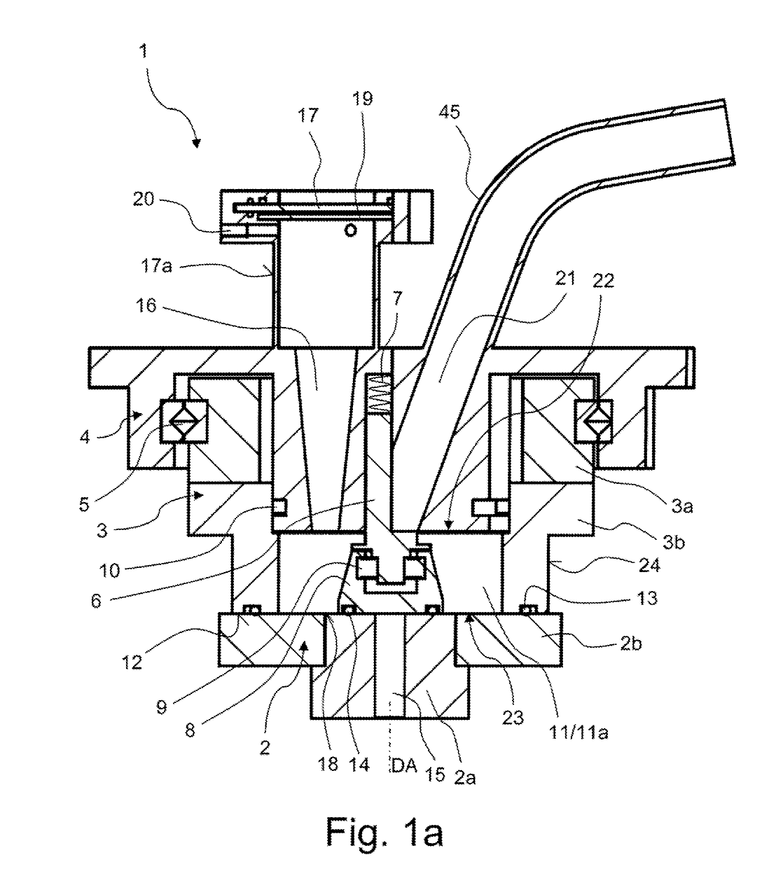

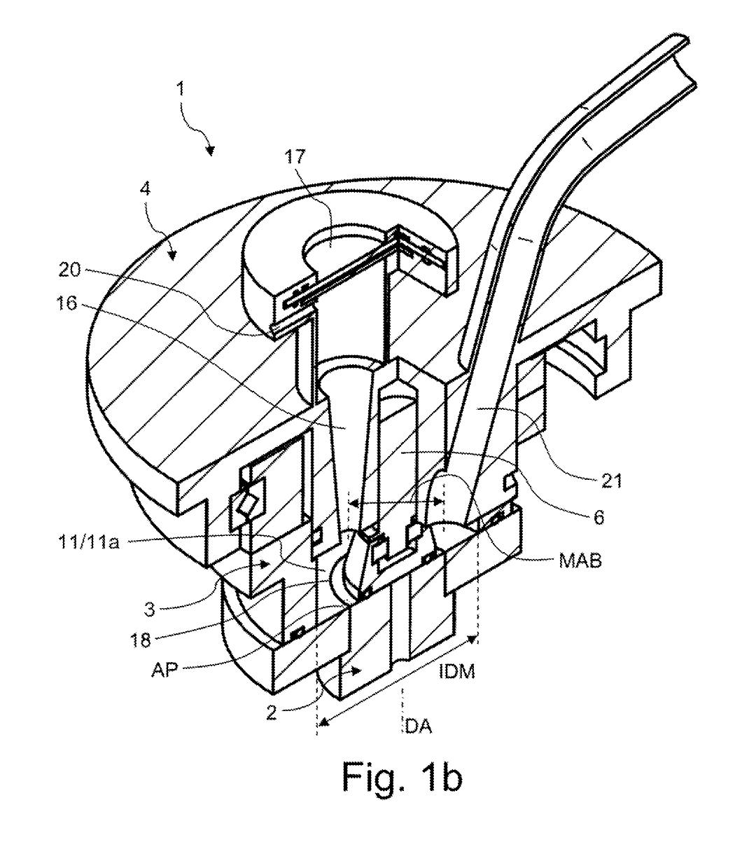

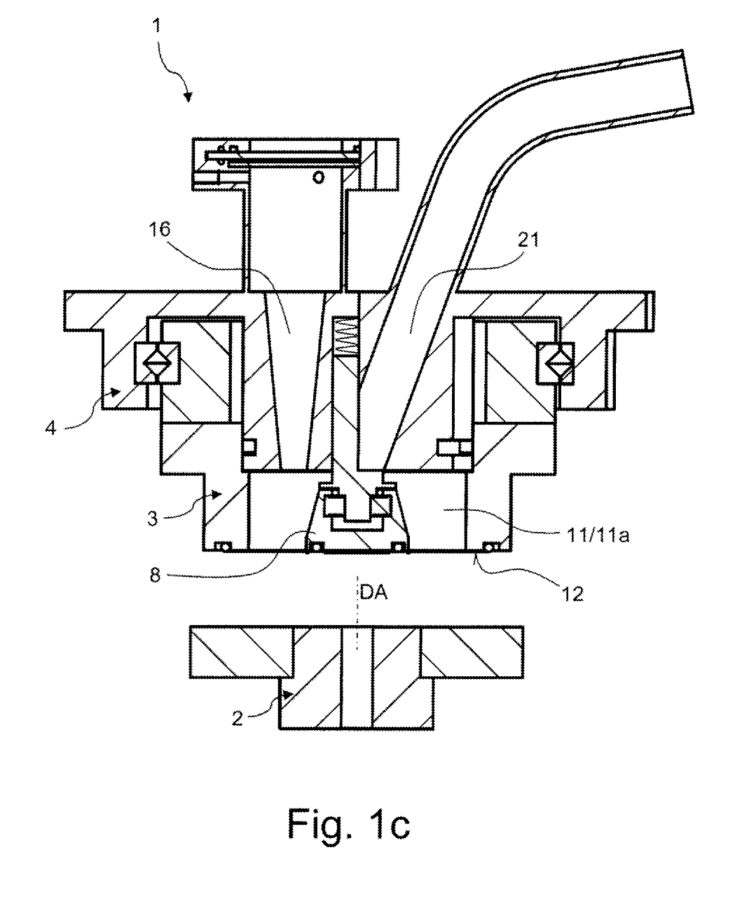

FIGS. 1a to 1c illustrate a first embodiment of a system 1 according to the invention for the laser welding of a multi-part workpiece 2.

As can be seen in particular from FIG. 1a, in this embodiment the system 1 comprises a two-part workpiece 2, with an inner, drilled portion 2a and an outer, annular portion 2b, and also welding mask 3 and a welding mask holder 4.

The welding mask 3 is mounted with an upper part 3a rotatably about an axis of rotation DA in the welding mask holder 4 by way of a bearing 5. On the welding mask holder 4 there is formed on the outside of an inner, downwardly protruding part a first, peripheral seal 10, which provides a gas-tight seal between the welding mask holder 4 and the welding mask 3 on a lower part 3b even during rotation of the welding mask 3. The upper and lower parts 3a, 3b of the welding mask 3 are permanently connected to one another in a fixed manner.

On the welding mask holder 4 there is also formed a slide 6, which can be moved along the axis of rotation DA in the rest of the welding mask holder 4. The slide 6 is pretensioned by a spring 7 into a position in which it is downwardly extended in FIG. 1a. An abutting element 8 is fastened to the slide 6 by way of a further bearing 9, wherein the abutting element 8 is in turn rotatable about the axis of rotation DA on the slide 6.

On an underside of the welding mask 3 there is formed an abutment 12 for abutting of the workpiece 2. On the abutment 12 there is formed a second, peripheral seal 13, which provides a gas-tight seal between the workpiece 2 and the welding mask 3.

Furthermore, on an underside of the abutting element 8 there is formed a third, peripheral seal 14, which provides a gas-tight seal between the workpiece 2 in the region around the bore 15 thereof and the abutting element 8.

A welding chamber 11 is bounded by the workpiece 2, the welding mask 3 and the welding mask holder 4. The welding mask holder 4 in this case reaches over an upper, first end-face opening 22 of a radial wall 24 of the welding mask 3, and the workpiece 2 reaches over a lower, second end-face opening 23 of the radial wall 24.

Leading into this welding chamber 11, through the welding mask holder 4, is a substantially straight laser channel 16, which in its lower part narrows downwardly. In the embodiment shown, in an upper part the laser channel 16 runs in an incoupling window holder 17a, which protrudes upward from the rest of the welding mask holder 4, and at the top ends at an incoupling window 17. In this case, a laser beam can be radiated into the laser channel 16 through the incoupling window 17 parallel to the axis of rotation DA, in order thereby to weld an annular connecting region 18 (cf. also in this respect FIG. 1b) of the two workpiece parts 2a, 2b. Provided in this case at the incoupling window 17, on the side facing the laser channel 16, is a protective glass 19, which is easily exchangeable in the event of contamination. Furthermore, provided in the region of the upper end of the laser channel 16 is an inlet (purging gas inlet) 20, through which in this case nitrogen from a reservoir (not represented any more specifically), for instance a pressurized gas cylinder, can enter the laser channel 16 with a gentle, constant stream.

Also leading into the welding chamber 11 through the welding mask holder 4 is a suction channel 21, by way of which the welding chamber 11 can be evacuated, for instance with a sliding vane rotary pump (not represented), which is connected by way of a preferably flexible connecting line 45.

The laser channel 16 and the suction channel 21 run straight in a lower part that is near the welding chamber and are both directed at a point of impingement AP (outlined by the dotted line) of the laser beam on the surface of the workpiece 2, to be specific at a place on the annular connecting region 18, cf. in particular FIG. 1b.

The mouths of the laser channel 16 and the suction channel 21 into the main space 11a (radially bounded substantially by the welding mask 3) of the welding chamber 11 have a center-to-center distance MAB, which in this case is about ½ of the inside diameter IDM of the main space 11a, measured in a plane perpendicular to the axis of rotation DA.

It should be noted that the sectional plane in FIG. 1b is stepped with respect to the welding mask holder 4, so that the welding mask holder 4 in the right-hand part of the representation projects with respect to the welding mask 3 and the workpiece 2.

For the laser processing of the workpiece 2, it is moved up to the welding mask 3 from a retracted position, which is shown in FIG. 1c, in order to seal the welding chamber 11. With the workpiece 2 not yet moved up, it can also be seen that the abutting element 8 protrudes slightly with respect to the abutment 12 because of the extended position of the slide 6.

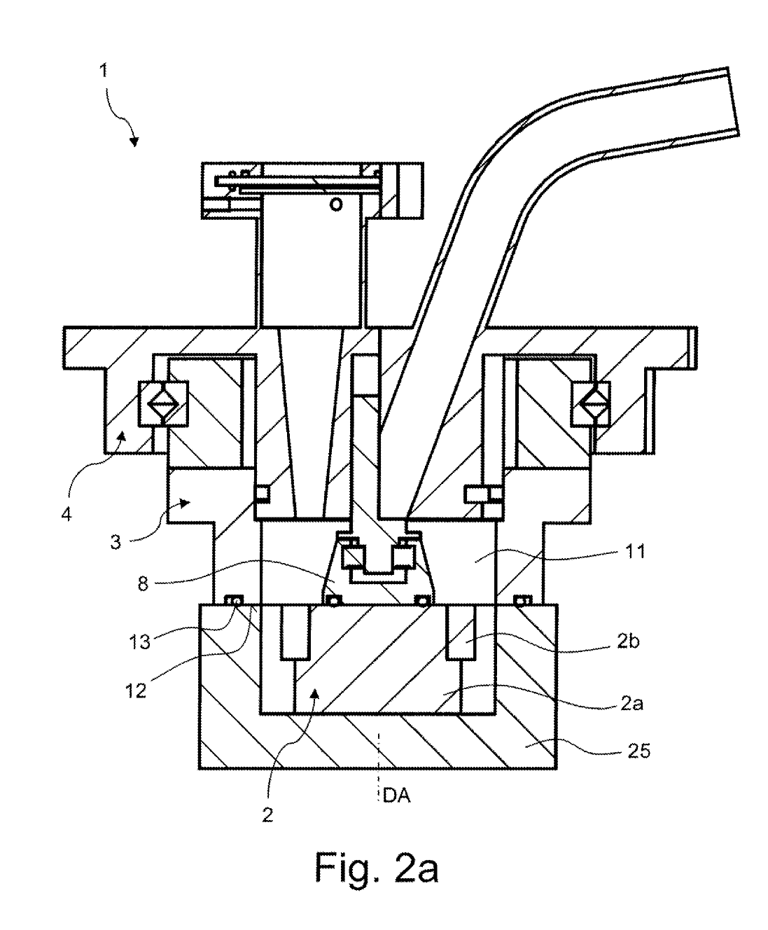

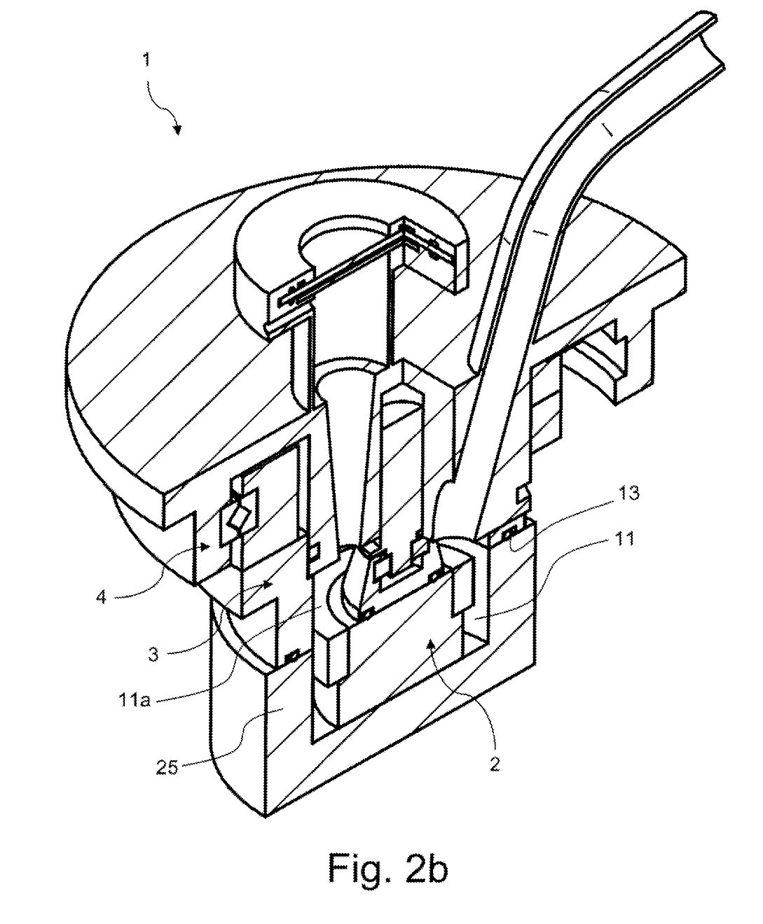

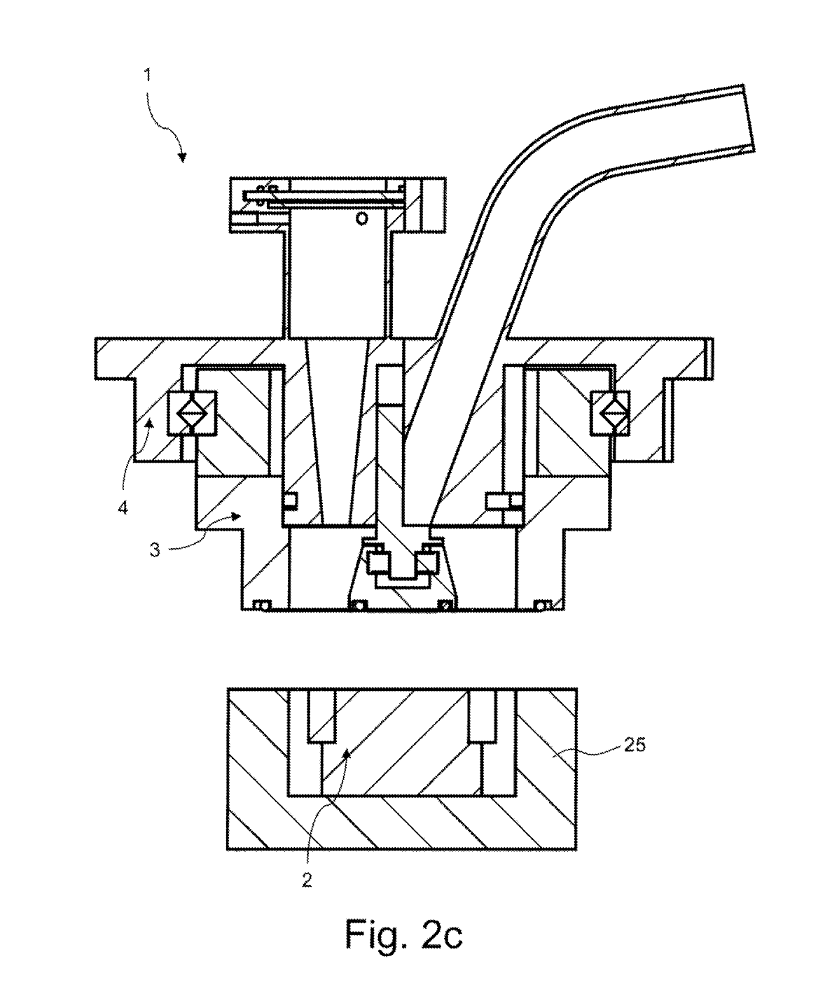

FIGS. 2a to 2c show a second embodiment of a system 1 according to the invention for laser welding, similar to the first embodiment from FIGS. 1a to 1c. Only the essential differences are explained below.

The two-part workpiece 2, comprising the inner workpiece part 2a and the outer workpiece part 2b, is arranged in this case on an approximately cup-shaped workpiece carrier 25 and is secured on the workpiece carrier 25 in a way that is not represented any more specifically. In order to close the welding chamber 11, the workpiece carrier 25 moves against the abutment 12 of the welding mask 3, so that the second, peripheral seal 13 provides a seal in this case between the workpiece carrier 25 and the welding mask 3. For the processing of the workpiece, the workpiece carrier 25 with the workpiece 2 and the welding mask 3 turns in relation to the stationary welding mask holder 4 with respect to the axis of rotation DA. It should be noted that a mutual engagement of the workpiece carrier 25 and the welding mask 3 can be set up in order to ensure that the welding mask 3 turns together with the workpiece carrier 25; usually, however, frictional connection obtained by placement is sufficient.

In the second embodiment shown, the workpiece 2 has not been drilled; the abutting element 8 serves in this case only for additionally securing the workpiece 2 on the workpiece carrier 25. On account of the enclosure by the workpiece carrier 25, however, workpieces 2 with channels, grooves, projections and sloping surfaces of all kinds can also be processed in this case without any problem.

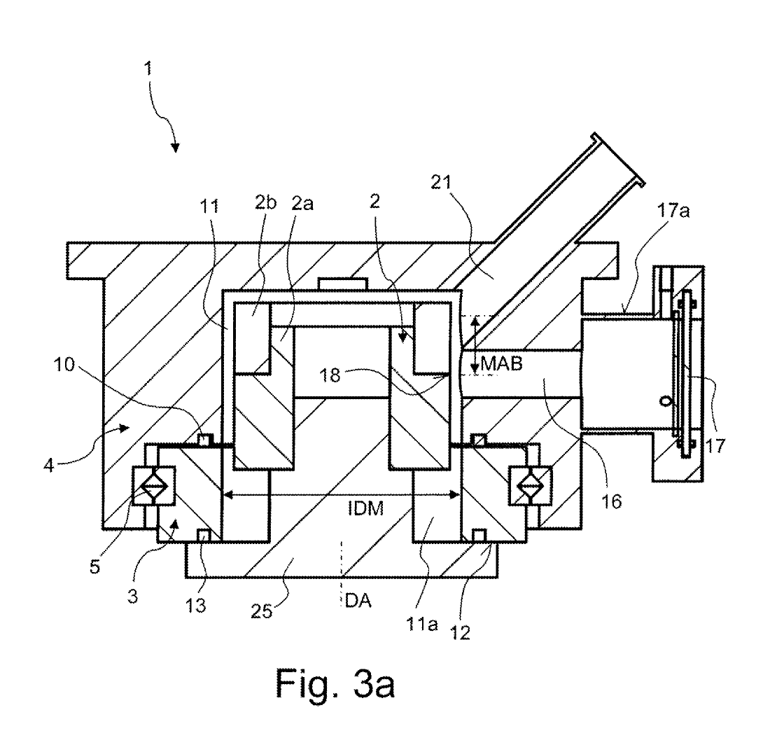

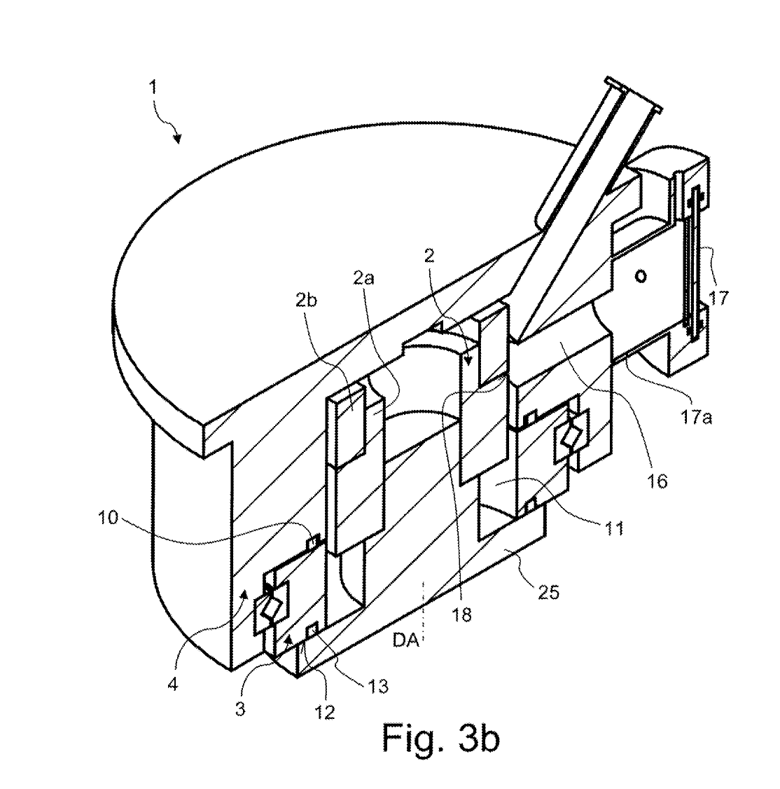

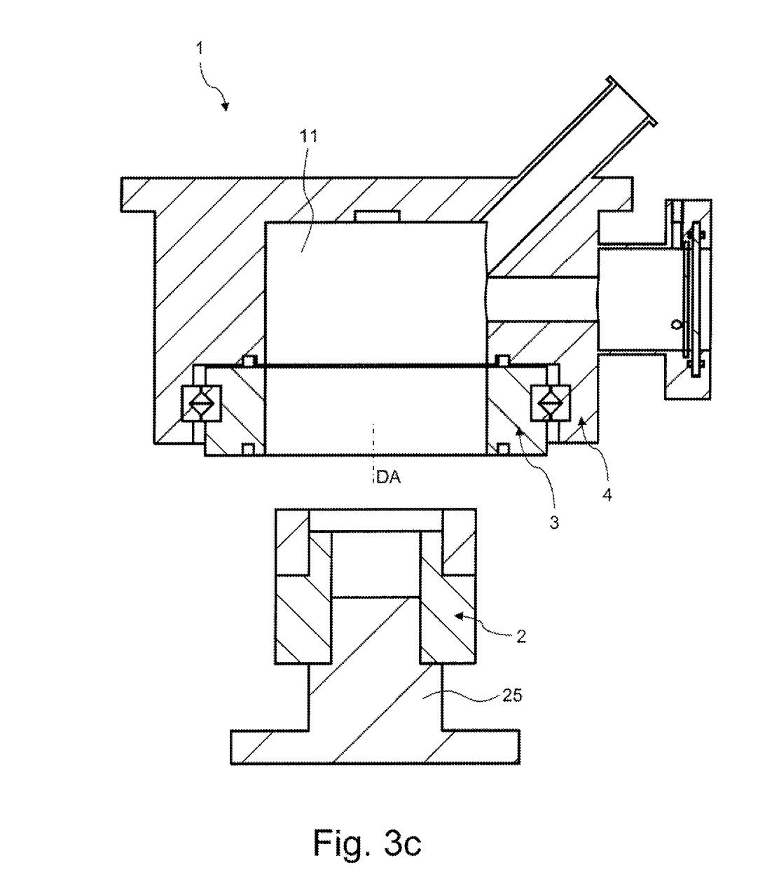

FIGS. 3a to 3c show a third embodiment of a system 1 according to the invention for laser welding, similar to the first embodiment from FIGS. 1a to 1c. Only the essential differences are explained below.

In this embodiment, the two-part workpiece 2, comprising the inner, drilled workpiece part 2a and the outer workpiece part 2b, is again held on a workpiece carrier 25, cf. in particular FIG. 3a and FIG. 3b. The welding mask 3, which is mounted rotatably about the axis of rotation DA in the welding mask holder 4, forms an abutment 12, and the second, peripheral seal 13 seals the workpiece carrier 25 with respect to the welding mask 3.

In this case, the laser channel 16 runs perpendicularly in relation to the axis of rotation DA, so that a peripheral connecting region 18 running radially outside on the workpiece 2, respectively the workpiece 2, can be welded by a laser beam (not represented) introduced through the incoupling window 17 and propagating in the laser channel 16. The incoupling window holder 17a protrudes in this case laterally from the welding mask holder 4.

The workpiece carrier 25 is moved parallel to the axis of rotation DA to the welding mask 3, in order to close the welding chamber 11, cf. FIG. 3c with the extended position.

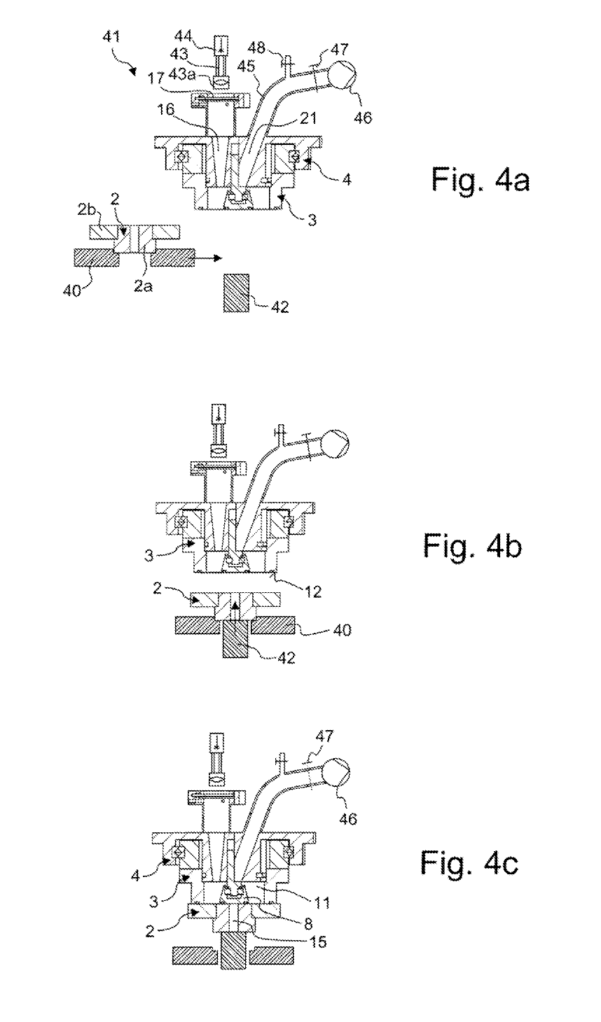

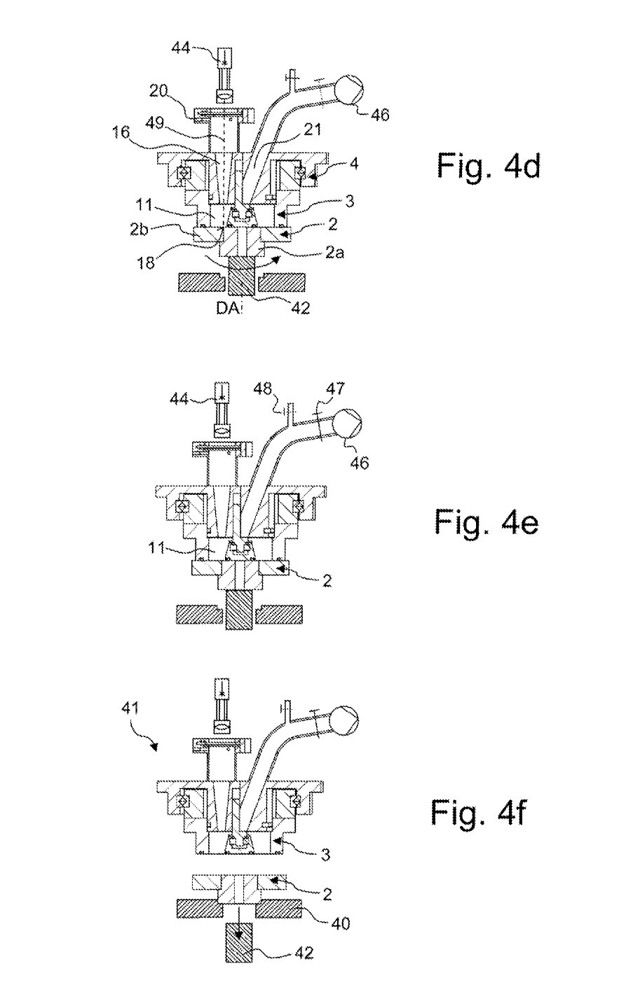

FIGS. 4a-4f illustrate the sequence of a variant given by way of example of the method according to the invention for the vacuum laser welding of an at least two-part workpiece 2. The method takes place in this case on the system that is represented in FIGS. 1a-1c.

As can be seen from FIG. 4a, a two-part workpiece 2, comprising an inner, drilled workpiece part 2a and an outer workpiece part 2b, is arranged on a mobile table 40, for instance a rotary table. The mobile table 40 moves the workpiece 2 in preparation to a laser welding station 41, comprising the in this case stationary welding mask holder 4 with the welding mask 3 mounted rotatably therein and a handling device (lifting device) 42.

Connected to the incoupling window 17 of the welding mask holder 4 by way of a welding optical system 43a and an optical fiber (optical waveguide) 43 is a laser 44, with which a laser beam can be radiated into the laser channel 16; the welding optical system 43a, which forms an image of a front end (facing the laser welding station 41) of the optical fiber 43, is in this case typically retracted slightly from the incoupling window 17. At the stage of the method that is shown in FIG. 4a, however, the laser beam has not yet been activated. Connected to the suction channel 21 is a connecting line 45 to a vacuum pump 46; at the stage of the method from FIG. 4a, however, a shut-off valve 47 in the connecting line 45 is still closed. At the connecting line 45 there is also formed a venting valve (air-admitting valve) 48, which at the stage of the method shown is likewise closed.

Once the workpiece 2 has been positioned by means of the mobile table 40 under the welding mask 3, the workpiece 2 is lifted out by means of the handling device 42 and moved to the abutment 12 of the welding mask 3 from below, cf. FIG. 4b. For this, in the variant shown the lifting device 42 reaches through a clearance in the mobile table 40.

This has the effect of closing the welding chamber 11, which in this case is bounded by the workpiece 2, the welding mask 3 and the welding mask holder 4, cf. FIG. 4c. The bore 15 in the workpiece 2 is also closed thereby, by way of the abutting element 8. Then, the evacuation of the welding chamber 11 can be begun. For this, the shut-off valve 47, which leads to the vacuum pump 46, is opened (cf. the representation in dotted lines).

As soon as the pressure in the welding chamber 11 has dropped to the desired pressure level, welding processing is begun, cf. FIG. 4d. The laser 44 generates a laser beam 49, which is directed through the laser channel 16 onto a point on the annular connecting region 18 of the two workpiece parts 2a, 2b. The handling device 42 is turned about the axis of rotation DA, whereby the workpiece 2 and the welding mask 3 are also turned along with it about the axis of rotation DA. Over a complete revolution, the laser beam 49 sweeps over the entire peripheral connecting region 18 and welds it.

During the laser processing, a gentle gas stream flows in via the inlet (purging gas inlet) 20 through the laser channel 16, past the workpiece 2, and through the suction channel 21 finally to the still pumping-out vacuum pump 46. As a result, contaminants on the workpiece 2 and in the welding chamber 11 can be reduced, and the quality of the processing can be increased.

As soon as the laser processing of the workpiece 2 has been completed, the laser beam of the laser 44 is deactivated, and the vacuum pump 46 is disconnected by means of the closed shut-off valve 47 (cf. the representation in solid lines), cf. FIG. 4e. Opening of the venting valve 48 (cf. the representation in dotted lines) has the effect that the pressure in the welding chamber 11 is adjusted to the ambient pressure.

Then, by lowering the handling device 42, the processed workpiece 2 can be withdrawn from the welding mask 3 and placed on the mobile table 40, cf. FIG. 4f.

By means of the mobile table 40, the workpiece 2 can subsequently be transported away, for instance by moving the mobile table 40 to the right, and a new, unprocessed workpiece can be moved to the laser welding station 41, whereby a new processing cycle begins (cf. FIG. 4a and thereafter).

### LIST OF REFERENCE SIGNS

1 System
2 Workpiece
2a, 2b Workpiece parts
3 Welding mask
3a, 3b Parts of the welding mask
4 Welding mask holder
5 Bearing
6 Slide
7 Spring
8 Abutting element
9 Bearing
10 First peripheral seal
11 Welding chamber
11a Main space of the welding chamber
12 Abutment
13 Second peripheral seal
14 Third peripheral seal
15 Bore
16 Laser channel
17 Incoupling window
17a Incoupling window holder
18 Annular connecting region
19 Protective glass
20 Inlet
21 Suction channel
22 First end-face opening
23 Second end-face opening
24 Radial wall
25 Workpiece carrier
40 Mobile table
41 Laser processing station
42 Handling device
43 Optical fiber
43a Welding optical system
44 Laser
45 Connecting line
46 Vacuum pump
47 Shut-off valve
48 Venting valve
49 Laser beam
AP Point of impingement
DA Axis of rotation
IDM Inside diameter of the main space
MAB Center-to-center distance

What is claimed is:

1. A method for the vacuum laser welding of an at least two-part workpiece, the method comprising the steps of:
(a) providing a workpiece or a workpiece carrier on which the workpiece is arranged, and providing a welding mask rotatably mounted in a welding mask holder;
(b) forming a welding chamber that is enclosed and sealed in a gas-tight manner by moving the workpiece or the workpiece carrier and the welding mask relatively toward one another and pressing against one another;
(c) evacuating the welding chamber;
(d) welding by a laser beam an annular connecting region between at least two workpiece parts of the workpiece that is exposed to the vacuum in the welding chamber, wherein the laser beam propagates through the welding chamber, and wherein the workpiece or the workpiece carrier together with the workpiece and the welding mask are turned in relation to the welding mask holder;
(e) admitting air to the welding chamber; and
(f) moving the workpiece or the workpiece carrier on which the workpiece is arranged and the welding mask relatively away from one another.

2. The vacuum laser welding method as claimed in claim 1, wherein on the welding mask holder there is formed an incoupling window, through which the laser beam is introduced into the welding chamber in step (d).

3. The vacuum laser welding method as claimed in claim 1, wherein the welding mask holder is fixed in place during the entire method, and in step (b) the workpiece or the workpiece carrier is moved to the welding mask, and in step (f) the workpiece or the workpiece carrier is moved away from the welding mask.

4. The vacuum laser welding method as claimed in claim 3, wherein before step (b) the workpiece or the workpiece carrier is moved by means of a rotary table under the welding mask holder, and during step (b) the workpiece or the workpiece carrier is lifted out of the rotary table, and in that during step (f) the workpiece or the workpiece carrier is placed on the rotary table, and after step (f) the workpiece or the workpiece carrier is moved by means of the rotary table away from the welding mask holder.

5. The vacuum laser welding method as claimed in claim 1, wherein during step (d) suction is constantly applied to the welding chamber with a constant pumping power, and gas is constantly admitted to the welding chamber with a constant gas stream.

6. The vacuum laser welding method as claimed in claim 5, wherein in the welding mask holder there is formed a substantially straight laser channel, in which the laser beam propagates in step (d) and which narrows toward a point of impingement (AP) of the laser beam at the connecting region, wherein in step (d) the gas is admitted in a portion of the laser channel that is away from the connecting region, and in that in the welding mask holder there is formed a substantially straight suction channel, which is at least approximately aligned with the point of impingement (AP) of the laser beam, wherein the suction channel widens away from the point of impingement (AP), and wherein in step (d) pumping out takes place at an end of the suction channel that is remote from the connecting region.

7. The vacuum laser welding method as claimed in claim 1, wherein the welding chamber formed in step (b) is bounded by the workpiece and/or the workpiece carrier, the welding mask and the welding mask holder.

8. A system for the laser welding of an at least two-part workpiece, comprising:
a workpiece or a workpiece carrier (25) for the workpiece;
a welding mask holder; and
a welding mask with an abutment for the workpiece and/or the workpiece carrier;
wherein the welding mask is mounted on the welding mask holder rotatably about an axis of rotation (DA);
wherein a first, peripheral seal is arranged on the welding mask or welding mask holder; and
a second, peripheral seal is arranged on the welding mask or on the workpiece carrier;
wherein when there is a workpiece and/or a workpiece carrier lying against the abutment of the welding mask, there is formed a gas-tight welding chamber which is bounded by the welding mask, the welding mask holder and the workpiece and/or the workpiece carrier (25);
wherein the first seal seals the welding mask holder with respect to the welding mask, and the second seal seals the welding mask with respect to the workpiece and/or the workpiece carrier (25); and
wherein in the welding mask holder there is formed a suction channel by way of which the welding chamber can be evacuated.

9. The vacuum laser welding system as claimed in claim 8, wherein there is also a vacuum pump which is connected to the suction channel.

10. The vacuum laser welding system as claimed in claim 8, wherein there is a venting valve with which air can be admitted to the welding chamber, wherein the venting valve is arranged at a connecting line to a vacuum pump that is connected to the suction channel.

11. The vacuum laser welding system as claimed in claim 8, wherein on the welding mask holder there is formed a slide which can move along the axis of rotation (DA) and which is pretensioned by a spring force into a position moved away from the rest of the welding mask holder, wherein arranged on the slide is an abutting element for abutting the workpiece, wherein the abutting element is mounted on the slide rotatably about the axis of rotation (DA), and wherein arranged on the abutting element is a third, peripheral seal with which a bore in the workpiece can be sealed when the workpiece is lying against the abutting element.

12. The vacuum laser welding system as claimed in claim 8, wherein an incoupling window for a laser beam is formed on the welding mask holder at an outer end of an incoupling window holder that protrudes from the rest of the welding mask holder.

13. The vacuum laser welding system as claimed in claim 8, wherein a substantially straight laser channel for the propagation of a laser beam is formed in the welding mask holder, wherein the laser channel narrows toward the workpiece to be welded, wherein an inlet for a gas is set up at a portion of the laser channel that is remote from the workpiece to be welded, wherein the suction channel is at least approximately aligned with a point of impingement (AP) of the laser beam on the workpiece to be welded, and furthermore the laser channel is aligned with the point of impingement (AP) of the laser beam on the workpiece to be welded, and wherein the suction channel is formed as substantially straight wherein the suction channel widens away from the workpiece to be welded.

14. The vacuum laser welding system as claimed in claim 13, wherein the suction channel and the laser channel open out with their ends that are facing the point of impingement (AP) of the laser beam into a main space of the welding chamber, wherein the ends have a center-to-center distance (MAB) less than or equal to ⅔ of the inside diameter (IDM) of the main space.

15. The vacuum laser welding system as claimed in claim 13, wherein the suction channel and the laser channel open out with their ends that are facing the point of impingement (AP) of the laser beam into a main space of the welding chamber, wherein the ends have a center-to-center distance (MAB) less than or equal to ½ of the inside diameter (IDM) of the main space.

16. The vacuum laser welding system as claimed in claim 8, wherein the volume of the welding chamber is 5 liters or less.

17. The vacuum laser welding system as claimed in claim 8, wherein the volume of the welding chamber is 3 liters or less.

18. The vacuum laser welding system as claimed in claim 8, wherein the volume of the welding chamber is between 0.2 liters and 2.5 liters.

19. The vacuum laser welding system as claimed in claim 8, wherein the welding mask is formed with an annular wall, wherein a first end-face opening is covered by the welding mask holder, and a second end-face opening which is bounded by the abutment can be covered by the workpiece and/or by the workpiece carrier.

20. The use of the vacuum laser welding system as claimed in claim 8 in a method as claimed in claim 1.
